(19) United States
(12) Patent Application Publication
(10) Pub. No.: US 2015/0051930 A1
(43) Pub. Date: Feb. 19, 2015

(54) APPLICATION DEVELOPMENT SALES SUPPORT SYSTEM

(71) Applicants: Hiroshi Yamaguchi, Tokyo (JP); Yasunori Gorai, Tokyo (JP)

(72) Inventors: Hiroshi Yamaguchi, Tokyo (JP); Yasunori Gorai, Tokyo (JP)

(73) Assignee: Hitachi Systems, Ltd., Shinagawa-ku, Tokyo (JP)

(21) Appl. No.: 14/388,327

(22) PCT Filed: Mar. 28, 2012
(86) PCT No.: PCT/JP2012/058159

§ 371 Date: Oct. 16, 2014

(51) Int. Cl. G06Q 10/06

(52) U.S. Cl. CPC G06Q 10/0631
USPC 705/7.12

(57) ABSTRACT

An application development sales support system for a mechanism in which IT vendors and other entities provide system development environments as services by means of cloud computing environments for providing support in providing suitable business materials at suitable timings in accordance with development statuses of clients utilizing the development environments as sales activities. The application development sales support system includes: a development status extracting unit for acquiring information of development statuses related to developments of application programs by the clients using the development environment from the development environment and recording them on a development status recording device; and an evaluation/analysis unit for outputting information related to corresponding specific sales instructions based on information of the development statuses of the clients recorded on the development status recording device when pieces of information match previously set rules.

### CROSS REFERENCE TO RELATED APPLICATIONS

This application is entitled to the benefit of and incorporates by reference subject matter disclosed in International Patent Application No. PCT/JP2012/058159 filed on Mar. 28, 2012.

### TECHNICAL FIELD

The present invention relates to a technique for supporting sales activities, and it particularly relates to a technique that is effectively applied to an application development sales support system for supporting sales activities of companies that provide and sell business materials such as products or services related to development of application programs in IT systems.

### BACKGROUND

In conventional sales activities of companies, it is generally the case that in case of existing clients, salespersons visit clients regularly or upon requests and others of clients. In case of new clients, salespersons visit clients upon inquiries from clients in response to promotions made by placing advertisements or providing websites, and there are also cases like so-called walk-in sales, that is, they actively visit clients.

However, in such sales activities, there are, for instance, cases in which regular visits to existing clients might be in vain since it is not yet a suitable stage for selling business materials or clients have already decided to make purchases from other companies. Further, not all actions in response to inquiries from new clients result in business talks since it is not yet a suitable stage for selling business materials. In this manner, due to the fact that sales activities cannot be carried out at favorable timings, there are many cases which come to nothing and often result in waste of business costs.

In contrast thereto, for instance, Japanese Patent Laid-Open Publication No. 2007-310851 recites a system for supporting sales in which patterns causing occurrence of cases and desirable activity steps corresponding to each of the patterns are set up as hypotheses, and by informing contents and suggested steps for the items causing occurrence of cases to salespersons by means of a search engine for detecting occurrence of items causing occurrence of cases included in the hypotheses based on movements of transaction history data, company data and other client data ideas are provided to tell which are important and difficult tasks in outside client business of suggesting-type business materials such as which clients to visit at the current stage, what kind of suggestions are to be made or how to proceed to salespersons during stages of developing cases.

### SUMMARY

The above-mentioned tasks involved in sales activities are also common to companies such as IT vendors, and particularly IT vendors who sell products, services or tools related to system development and who provide human resources such as engineers to support system development projects, and it is often the case that even when the IT vendors perform sales activities upon providing a selection of various business materials, the suggested business materials are not required by the clients at that time. This is because it is not necessarily the case that system developments are regularly performed, and since there are phases of developments, it might be that required business materials differ depending on those phases.

On the other hand, utilization of cloud computing environments is spreading in various IT services and systems in these days. For instance, the above-described IT vendors might also provide development environments that are used in system developments (for instance, tools with functions of creating screens or creating/generating source codes, build or version management) in form of services utilizing cloud computing environments. In such cases, with consents of users who perform system development utilizing such development environment services, it is possible for IT vendors who provide development environment services to hold information related to development statuses of such users. The IT vendors and other entities might carry out sales activities in an effective manner while minimizing business costs by effectively utilizing such information.

It is accordingly an object of the present invention to provide an application development sales support system for a mechanism in which IT vendors and other entities provide system development environments as services by means of cloud computing environments for providing support in providing suitable business materials at suitable timings in accordance with development statuses of users (clients) utilizing the development environments as sales activities. The above and other preferred aims and novel characteristics of the present invention will be apparent from the description of the present specification and the accompanying drawings.

The typical ones of the inventions disclosed in the present application will be briefly described as follows.

An application development sales support system according to a typical embodiment of the present invention is an application development sales support system for supporting sales activities of a company who provides a development environment for developing application programs to users of clients via a network in a cloud computing environment, the application development sales support system including: a development status extracting unit for acquiring information of development statuses related to developments of application programs by the clients using the development environment from the development environment and recording them on a development status recording device, and an evaluation/analysis unit for outputting information related to corresponding specific sales instructions based on information of the development statuses of the clients recorded on the development status recording device when pieces of information match previously set rules.

The effects obtained by typical aspects of the present invention will be briefly described below.

Namely, according to a representative embodiment of the present invention, it is made possible to provide support, for a mechanism in which IT vendors and others provide system development environments as services by means of cloud computing environments, in providing suitable business materials at suitable timings in accordance with development statuses of users (clients) utilizing the development environments as sales activities and to perform sales activities in an effective manner while minimizing business costs.

### BRIEF DESCRIPTIONS OF THE DRAWINGS

FIG. 1 is a diagram illustrating a scheme of a configuration example of an application development sales support system which is one embodiment of the present invention;

FIG. 2 is a diagram illustrating a scheme of data construction example of a development status DB according to one embodiment of the present invention;

FIG. 3 is a diagram illustrating a scheme of data construction example of a salesperson DB according to one embodiment of the present invention;

FIG. 4 is a diagram illustrating a scheme of data construction example of a business material DB according to one embodiment of the present invention;

FIG. 5 is a diagram illustrating a scheme of data construction example of an advertisement DB according to one embodiment of the present invention;

FIG. 6 is a diagram illustrating a scheme of data construction example of a client DB according to one embodiment of the present invention;

FIG. 7 is a diagram illustrating a scheme of data construction example of a rule DB according to one embodiment of the present invention; and

FIG. 8 is a flowchart illustrating a scheme of a process flow example at the time of performing business instructions using a sales support server according to one embodiment of the present invention.

### DETAILED DESCRIPTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

The application development sales support system which is one embodiment of the present invention is a system for providing support for IT vendors providing development environments of application programs in IT systems as services by means of cloud computing environments in providing suitable business materials at suitable timings in accordance with development statuses of users (clients) utilizing the development environments as sales activities to clients (that is, companies and other entities performing system development utilizing the development environment service).

Accompanying expanded utilization of cloud computing environments, IT vendors might provide development environments (for instance, tools with functions of creating screens or creating/generating source codes, build or version management) that had conventionally been provided upon introducing them to individual computer equipment such as servers or PCs (personal computers) or the like in form of service utilizing cloud computing environments.

Generally, when providing such services, there are cases in which compensations for providing services are collected in form of monthly fees or meter rate charges and cases in which services are provided for free. In the latter case, there are cases in which, for instance, functions are restricted for specified functions such that they become available upon paying premiums or in which advertisements are displayed on-screen in which such advertisements can be hidden by paying premiums.

In the present embodiment, while there are cases in which collection of charges (collection of acquisition costs) is performed in the above-described method as compensations for providing development environment services and cases in which development environment services are, in principle, provided to clients for free without collecting charges, irrespective of the presence/absence of charges, peculiar information (development statuses of clients or statuses of utilizing development environment services) that are stored with the clients who uses the development environment services are made to be available by the IT vendor in exchange for providing development environment services in order to acquire information for supporting sales activities of the IT vendor.

In the present embodiment, by holding information related to development environment statuses based on the obtained information and by timely selling and suggesting suitable business materials at suitable stages in accordance with development statuses, it is made possible to minimize business costs and to perform sales activities in an effective manner.

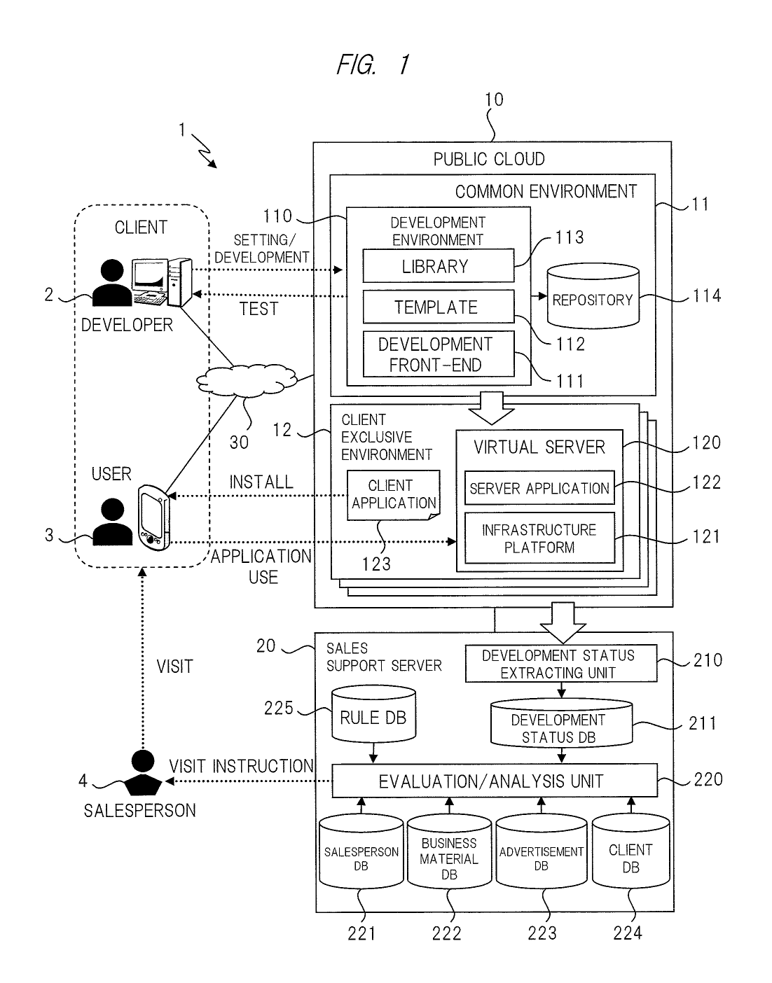

FIG. 1 is a diagram illustrating a scheme of a configuration example of an application development sales support system which is one embodiment of the present invention. The application development sales support system 1 includes, for instance, a public cloud 10 as a cloud computing environment through which IT vendors and other entities provide development environment services of application programs (for instance, mobile applications providing services on portable terminals) and a sales support server 20 for supporting sales activities by holding development statuses of users (clients) based on information acquired and collected through the development environment services provided on the public cloud 10 and performing instructions of sales activities such as visits by salespersons for selling or suggesting business materials or displaying advertisements in accordance with the statuses.

The public cloud 10 includes, for instance, a common environment 11 through which IT vendors and other entities provide development environments as services in common to a plurality of users (clients) and client exclusive environments 12 that are individually provided to each of the clients for carrying out execution of applications and others developed by the clients.

The common environment 11 includes, for instance, a development environment 110 for providing development environment services and a repository 114. The development environment 110 is mounted on a virtual server on the public cloud 10 as a software such as an ASP (application service provider) and provides users such as a developer 2 and others who access through networks 30 such as the Internet with various functions included in the development environment services and tools of general applications such as creating screens or creating/generating source codes, builds or version management.

The development environment 110 comprises structures such as a development front-end 111, a template 112, and a library 113 and others. The development front-end 111 provides users such as the developer 2 and others who utilize the development environment services with functions as a front-end including user interfaces. The template 112 provides screen transitions, screen structures or source codes that are often used in developing applications as templates. The library 113 provides SDKs (software development kits) and various libraries that are necessary for creating source codes and builds of applications. The repository 114 is a database for holding deliverables created by the development environment 110 (for instance, client programs, server programs or logic parameters).

The development environment 110 automatically builds a client application 123 which is an application to be distributed to clients and or a server application 122 which is an application operating on the server, deploys the generated client application 123 on object client exclusive environments 12 to be distributable, and constructs a virtual server 120 for operating the generated server application 122 on the client exclusive environments 12 to deploy the server application 122. These processes can also be performed manually. In this respect, the virtual server 120 on the client exclusive environments 12 includes, for instance, a middleware such as an OS (operating system) for operating the server application 122 and an infrastructure platform 121 for providing platform service such as a CPU, storage and network.

In such development environment services, the developer 2 of a client company accesses the development environment 110 via the network 30 and easily performs developments and tests of prototypes or mockups for mobile applications by utilizing a previously defined template 112 and others. Completed applications (client application 123, server application 122) are deployed on the client exclusive environments 12, and a user 3 downloads and installs the client application 123 or a portable terminal and others via the network 30 and utilizes the application upon accessing the server application 122 on the virtual server 120 from the portable terminal and others.

On the other hand, the sales support server 20 is comprised by a computer system such as a server equipment or PC, and includes respective portions such as a development status extracting unit 210 or an evaluation/analysis unit 220 that are mounted as software. It further includes various tables such as a development status DB 211, a salesperson DB 221, a business material DB 222, an advertisement DB 223, a client DB 224 or a rule DB 225 which are comprised of databases (hereinafter also merely referred to as “DB”) and file tables.

The development status extracting unit 210 monitors data held by the common environment 11 (development environment 110) or the client exclusive environments 12 on the public cloud 10, extracts information related to development statuses or statuses of utilization of development environment services of clients (or projects being developed by clients) (hereinafter, these pieces of information might also be generally referred to as “development statuses”) and stores them in the development status DB 211. For instance, by accumulating frequencies or lengths of time of the developers 2 of clients access each of the functions provided by the development environment 110 based on log information recorded by the development environment 110, it is possible to judge current development phases (for instance, setting and design such as screen transition or structure, logic creation, test, application and others).

It is further possible to hold information related to residence times of current phases or information related to statuses of utilization such as numbers of simultaneously using users of the development environment 110 and numbers of hits (accesses). In case clients have registered attribute information in utilizing the development environment 110, it is also possible to acquire these pieces of information.

The evaluation/analysis unit 220 evaluates and analyzes contents of the development status DB 211 and others based on rules registered in the rule DB 225 to perform instructions and others to suggest suitable business materials in accordance with development statuses of the clients. For instance, when holding statuses in which clients retain at a specified phase during development for a long time, possibilities are high that the clients cannot proceed due to some kind of trouble so that it might be that instructions are issued to a salesperson 4 to visit and suggest technical support services and others.

Further, in case of clients who retain, for instance, in the test phase for a long time, it is possible to display advertisement contents for suggesting various development support tools that match the development phase such as suggesting a test automation tool on the development screen via the development front-end 111 of the development environment 110. For clients who utilize applications on the client exclusive environments 12, it might be that instructions are issued to the salesperson 4 to visit and suggest construction of regular environments for performing active developments from completed prototypes or mockups or expanded services including kitting of portable terminals. In this manner, it is made possible to suggest suitable business materials at suitable timings in accordance with development statuses of clients.

FIG. 2 is a diagram illustrating a scheme of data construction example of the development status DB 211. The development status DB 211 is a table that holds information related to development statuses of clients (or projects being developed by clients) extracted from data held by the common environment 11 (development environment 110) or the client exclusive environments 12 on the public cloud 10, and includes, for instance, items such as client ID, project ID, number of screens, number of codes, current development phase, residence time, number of simultaneously using users and number of hits.

The item of the client ID holds information related to client IDs (to be described later) for specifying clients who are performing (or who have performed) development projects utilizing the development environment 110. The item of the project ID holds information for uniquely identifying projects which object clients are developing (or have developed) utilizing the development environment 110. The items of the number of screens and number of codes respectively hold information related to the number of screens and number of source codes to be developed (or that have been developed) in object projects as information representing scales of projects.

The item of the current development phase holds information indicating current development phases of object clients (projects) that have been determined by the development status extracting unit 210. The item of the residence time holds information how long object clients (developers 2) retain at object development phases. As mentioned above, when residence times are longer by a specified length than standard ones, possibilities are high that clients cannot proceed due to some troubles. Accordingly, business materials such as technical support services, tools or products are determined by the evaluation/analysis unit 220 which might contribute to solutions thereof.

The item of the number of simultaneously utilizing users holds information related to the number of users (developers 2) of clients that have simultaneously accessed the development environment 110. These values are obtained, for instance, based on average values or maximum values of immediate fixed times. The item of the number of hits holds sums of numbers of hits for the development environment 110 to the current development phase. It is possible to get hold of the degree of concentration of utilization by clients based on these values, and when the degree of concentration is high, it is possible to determine business materials such as tools or products for supporting operations at object phases by means of the evaluation/analysis unit 220 to be object of sales instructions. For instance, by making advertisements related to the business materials be displayed on the development screen via the development front-end 111 of the development environment 110, it is possible to improve advertising effects by increasing the frequency of reference to advertisements.

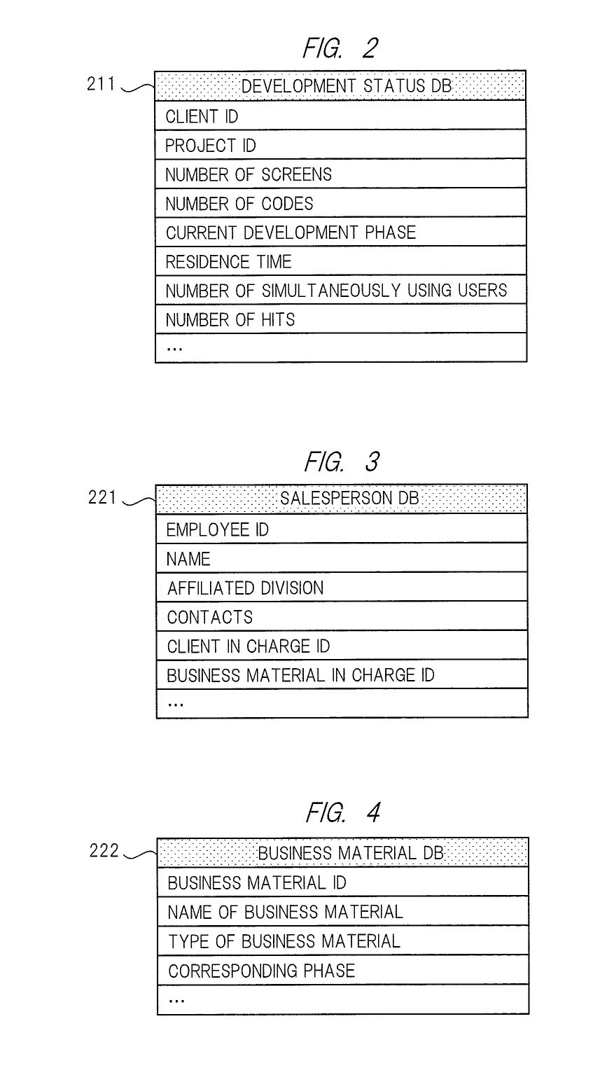

FIG. 3 is a diagram illustrating a scheme of data construction example of the salesperson DB 221. The salesperson DB 221 is a table for holding information related to salespersons 4 who perform sales activities, and includes items such as employee ID, name, affiliated division, contacts, client ID in charge, and business material ID in charge and others. The item of the employee ID holds ID information such as employee numbers for uniquely identifying salespersons 4. The item of the name holds information of names of object salespersons 4. The items of the affiliated division and contacts respectively hold information related to affiliated divisions of the object salespersons 4 and their contacts such as telephone numbers or e-mail addresses. The item of the client ID in charge holds information related to client IDs (to be described later) for specifying one or more clients the object salespersons 4 are in charge of. The item of the business material ID in charge holds information related to business material IDs (to be described later) for specifying one or more business materials the object salespersons 4 are in charge of sales/suggestions.

FIG. 4 is a diagram illustrating a scheme of data construction example of the business material DB 222. The business material DB 222 is a table for holding information related to business materials that the IT vendors and other who provide the development environment 110 can sell/suggest, and includes items such as business material ID, business material name, business material type, and corresponding phase. The item of the business material ID holds ID information for uniquely identifying respective business materials. The item of the business material name holds information related to names of object business materials (product names or service names and others). The item of the business material type holds information related to types of object business materials (classification of product/service or categories therein). The item of the corresponding phase holds information of one or more development phases that the object business materials correspond (apply).

FIG. 5 is a diagram illustrating a scheme of data construction example of the advertisement DB 223. The advertisement DB 223 is a table for holding information related to advertisements of business materials that IT vendors and other entities who provide the development environment 110 can sell/suggest, and includes items such as advertisement ID, corresponding business material ID, corresponding phase, output media and advertisement contents.

The item of the advertisement ID holds ID information for uniquely identifying respective advertisements. The item of the corresponding business material holds information related to business material IDs for specifying business materials that correspond to object advertisements. The item of the corresponding phase holds information of one or more development phases that correspond to object advertisements, that is, to which object advertisements are to be displayed. The item of the output media holds information of one or more media to which object advertisements are output. For instance, it is possible to make advertisements to be output to screens via the development front-end 111 of the development environment 110 or to forcibly set advertisement regions at the time of development/build of the client application 123 in the development environment 110 such that advertisements are displayed on screens of the client application 123. Further, it is also possible to make advertisements be displayed on websites when clients access websites such as those of their companies. The item of the advertisement contents holds contents data of advertisements (or information indicating their locations).

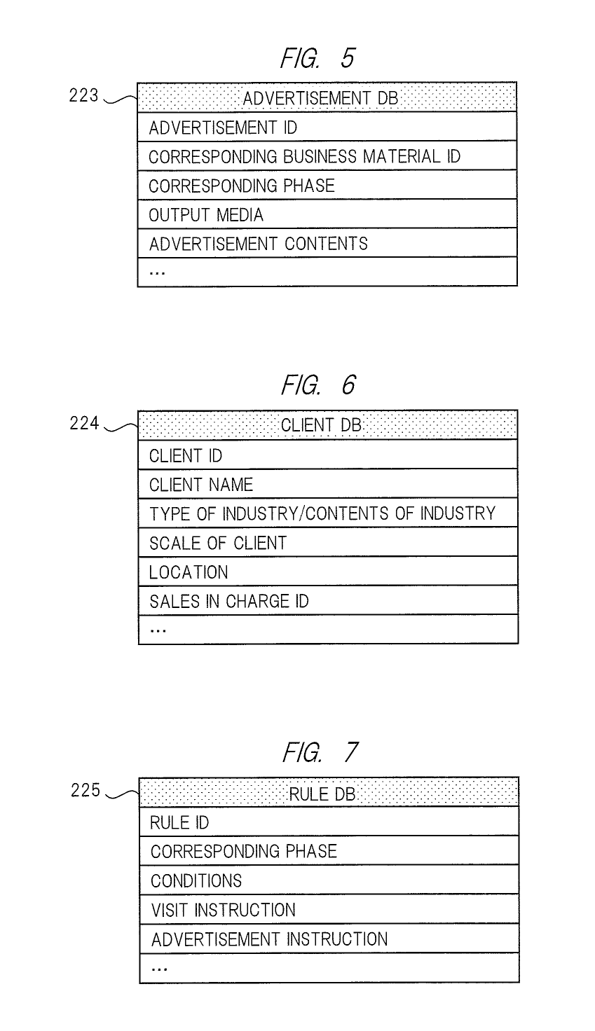

FIG. 6 is a diagram illustrating a scheme of data construction example of the client DB 224. The client DB 224 is a table for holding information related to attributive information and others related to client companies who utilize the development environment 110, namely, client companies object of sales activities for IT vendors and other entities who provide development environment services, and includes items such as client ID, client name, type of industry/contents of industry, scale of client, location and sales in charge ID.

The item of the client ID holds ID information for uniquely identifying client companies. The item of the client name holds information of names of object clients. The items of type of industry/contents of industry and scale of client respectively hold information related to categories of types of industries or contents of industries of object clients and information of scales such as number of employees. The item of the location holds information of locations of object clients. The item of the sales in charge ID holds information of employee IDs of IT vendors providing the development environment 11 for specifying one or more salespersons 4 who is in charge of sales for object clients.

FIG. 7 is a diagram illustrating a scheme of data construction example of the rule DB 225. The rule DB 225 is a table for holding information related to rules at the time of evaluating/analyzing contents of the development status DB 211 in the evaluation/analysis unit 220 for making sales instructions, and includes items such as rule ID, corresponding phase, conditions, visit instruction and advertisement instruction.

The item of the rule ID holds ID information for uniquely identifying respective rules. The item of the corresponding phase holds information of one or more development phases to which object rules are to be applied. The item of the condition holds information of conditions when object rules are to be applied. It is, for instance, possible to designate conditions that are applied to all clients in specified development phases such as “in the setting phase” or various conditions corresponding to development statuses of phases such as “residence time in the test phase longer than a specified time”, “same screen corrected for a number of times” or “specified time elapsed since start of utilization (test) using real machines in client exclusive environments” and others. In this respect, while conditions have been illustrated here by wordings as a matter of convenience, they are expressed as evaluation formula utilizing parameters indicating information held in the development status DB 211 and others at the time of mounting.

The items of visit instruction and advertisement instruction respectively hold contents of visit instructions when object rules are applied since they match the above items of the corresponding phases and the conditions. For instance, the item of the visit instruction holds ID information for specifying business materials to be sold/suggested to clients of destinations and ID information of salespersons 4 who receive the instructions (or conditional expressions for determining them). The item of the advertisement instruction holds ID information for specifying advertisements to be output (or output media), clients object of output and period of output (or conditional expressions for determining them).

In this respect, the above-described data structures (items) of respective tables shown in FIG. 2 to FIG. 7 are only examples, and other table structures and data structures could be used as far as the structure can hold and manage the same data.

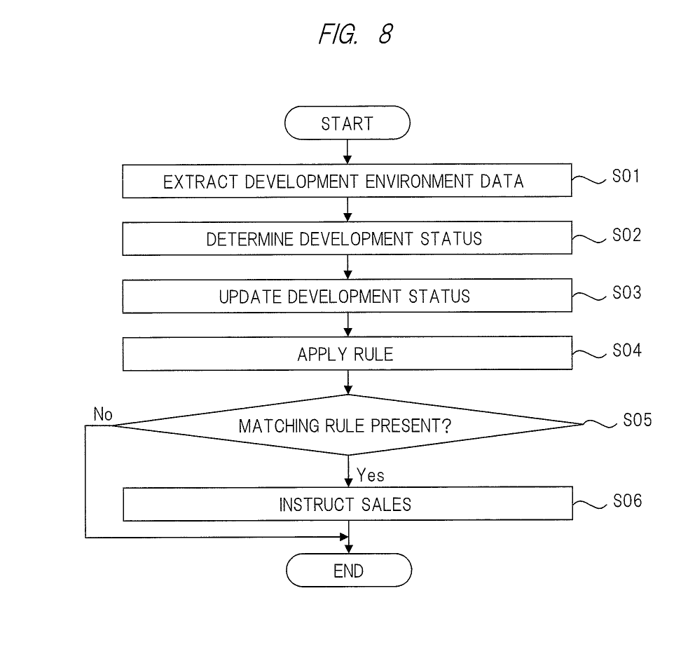

FIG. 8 is a flowchart showing a scheme of a process flow example at the time of performing sales instructions using the business support server 20. First, the development state extracting unit 210 extracts data related to development of clients from among data held by the development environment 110 or the client exclusive environments 12 on the public cloud 10 (S01). Information to be extracted could be information such as access log of developers 2 of clients to the development environment 110, design information or statuses of creating deliverables.

Thereafter, development statuses of clients including a current development phase are determined based on the extracted information (S02). The development phase is determined, for instance, by accumulating frequencies and lengths of time developers 2 of clients access respective functions provided by the development environment 110 or what kind of deliverables are created to what extent based on information such as access logs. Information related to residence times of current development phases and information related to statuses of utilization such as number of simultaneously using users and numbers of hits are also held. Thereafter, these pieces of information are recorded on the development status DB 211 (S03).

Thereafter, rules that are previously set in the rule DB 225 are applied to the contents of the development status DB 211, and it is determined whether they match designated conditions or not (S04). Thereafter, it is determined whether there are rules that match the conditions or not (S05), and when there are no rules that match the conditions, processes are terminated. When there are rules that match the conditions in step S05, sales instructions are made in accordance with contents designated by the rules (visit instructions, advertisement instructions) (S06), and processes are terminated.

For instance, by referring to the contents of the salesperson DB 221, the business material DB 222 or the client DB 224, e-mails are sent to relevant salespersons 4 or their managers to instruct them to sell/suggest object business materials to object clients or notices are made via the sales support server 20 or screens of client terminals accessing thereto. Further, by referring to contents of the business material DB 222, the advertisement DB 223 or the client DB 224, settings are made to display corresponding advertisements on screens of users (developers 2) of object clients via the screen front-end 111 of the development environment 110 or displaying corresponding advertisements on a screen of the client application 123 that is downloaded and installed from the client exclusive environment 12.

In this respect, the above-described series of processes of steps S01 to S06 are, for instance, executed at regular timings such as on daily bases and are also executable manually in a suitable manner.

As explained above, according to the application development sales support system 1 which is one embodiment of the present invention, for a framework in which IT vendors and other entities provide development environment services of applications by means of cloud computing environments as services, development statuses of clients are held based on information acquired and collected using the development environment services, and it is made possible to perform instructions of sales activities such as visits of salespersons for selling and suggesting suitable business materials or displays of advertisements at suitable timings based on these statuses.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention is applicable to application development sales support systems for supporting sales activities of companies who suggest and sell business materials such as products and services related to development of application programs in IT systems.

While the present invention has been illustrated and described with respect to a particular embodiment thereof, it should be appreciated by those of ordinary skill in the art that various modifications to this invention may be made without departing from the spirit and scope of the present.

What is claimed is:

1. An application development sales support system for supporting sales activities of a company who provides a development environment for developing application programs to users of clients via a network in a cloud computing environment, the application development sales support system comprising:
a development status extracting unit for acquiring information of development statuses related to developments of application programs by the clients using the development environment from the development environment and recording them on a development status recording device; and
an evaluation/analysis unit for outputting information related to corresponding specific sales instructions based on information of the development statuses of the clients recorded on the development status recording device when pieces of information match previously set rules.

2. The application development sales support system according to claim 1, wherein information of the development statuses includes information of development phases up to the points of processing of development processes of the clients as determined based on information acquired by the development status extracting unit from the development environment.

3. The application development sales support system according to claim 2, wherein the information of the development statuses includes information of residence times of the clients in the development phases.

4. The application development sales support system according to claim 1, wherein the information of the development statuses includes information of the number of users of clients simultaneously using the development environment and/or the numbers of hits to the development environment.

5. The application development sales support system according to claim 1,
wherein the information of sales instructions output from the evaluation/analysis unit includes information of visit instructions for selling or suggesting specified business materials to clients.

6. The application development sales support system according to claim 1,
wherein the information of sales instructions output from the evaluation/analysis unit includes information of advertisement instructions for displaying advertisements related to specified business materials on a screen of the development environment used by the clients and/or screens of applications developed by the clients using the development environment.
